(19) United States
(12) Patent Application Publication
(10) Pub. No.: US 2002/0027158 A1
(43) Pub. Date: Mar. 7, 2002

(54) Food container and wrap combination

(76) Inventors: Hugh Rae, Glen Rock, NJ (US); James F. Zavatone, Dover, MA (US); Linda A. Bernstein, Maineville, OH (US)

Correspondence Address: Joshua S. Broitman, Ostrager Chong & Flaherty LLP, 825 Third Avenue, New York, NY, 10022-7519, US

(21) Appl. No.: 09/931,972

(22) Filed: Aug. 17, 2001

Related U.S. Application Data
(60) Provisional application No. 60/225,950, filed on Aug. 17, 2000.

(51) Int. Cl. B65D 65/10; B65D 65/22; B31B 19/60; B31B 1/60

(52) U.S. Cl. 229/87.19; 229/938; 493/210; 426/115

(57) ABSTRACT

This invention provides an improved food package, and method for producing the food package, which combines an individual food container with a wrap. The food package makes the process of wrapping a food, such as a hamburger, more efficient and makes the food easier to eat. The food package may be a bag or a carton of any composition suitable for the purpose of holding a food item. The food container is attached to a wrap that has a length and width significantly larger than the dimensions of the food container. The method for producing the food package includes unwrapping and cutting of a wrap material on the same vacuum belt assembly as an adhesive application and a hopper feeder.

### RELATED APPLICATION

This application claims priority from United States Provisional Patent application 60/225,950 filed Aug. 17, 2000.

### FIELD OF THE INVENTION

The present invention relates to a combination food package comprising a food container attached to a flexible wrap, and to a method and apparatus for combining and attaching an individual container with a flexible wrapping material.

### BACKGROUND OF THE INVENTION

It is well known to enclose a food product, such as a hamburger or other sandwich type food, in a food packaging to achieve several purposes. These purposes include the conveyance of food to another person or place, the holding of a food product together, and the maintenance of temperature. Such food packages are often utilized in the fast food industry, where a wide range of sandwiches are available on a variety of different breads, including rolls, pita bread, tortillas and other sliced breads. Often, these food packages consist of a soft, flexible wrap material that encloses the food product without sealing, fastening or bonding so that a consumer may unwrap the product without tearing or breaking the package. After removing the food from the wrap, the consumer may use the wrap as a protective napkin against dripping juices and sauces that fall from the food. In this instance, however, the consumer must remove the food product completely from the wrap, most likely with their hands. Consequently, the consumer's fingers are subject to unwanted grease or heat sensations. Another problem with wrapping a food in a flexible wrap material is that the food product itself may be subject to crushing and molding if, for example, the food is transported in a paper bag with additional content.

Other food containers are shaped like pockets having one open end, e.g., a French scoop, and may be made from a soft flexible material or a more rigid paperboard structure. In these containers, the food product is placed into the pocket, and is not completely covered. The uncovered part provides the consumer access to the food product without removing it from the container. Thus, the consumer may consume the food while holding still holding the container, and, as a result, the consumer's fingertips are free of the food's heat and grease. However, these containers are substantially the same size as the product they contain, and, additionally, the containers have leakage problems, as juices and sauces leak through small holes at the container's bottom. Consequently, the container provides poorer protection against dripping juices and sauces than the flexible wrap. Furthermore, by not completely enclosing the product, the food product within the container is subject to heat and moisture loss as well as outside contaminants prior to consumption.

Additional types of food containers have a rigid structure and are shaped like a clamshell to completely enclose the food product. This type of container is easily opened and closed by a consumer and provides good protection of the food product. However, these rigid containers, like the pocket containers, are substantially the same size as the product that they house, and such containers also have leakage problems, as juices and sauces leak through small holes at the container's bottom. As a result, the container provides poorer protection against dripping juices and sauces than the flexible wrap. Furthermore, these containers require the consumer to remove the food product with their hands, subjecting the consumer's fingers to unwanted grease or heat sensations.

To achieve the benefits of flexible wrap, which provides protection from dripping juices and sauces and completely encloses the food, and the smaller food container, which provides better protection to the food product and may allow consumption of the food by the consumer without touching the food, the food product may be placed within a container, and then wrapped in a flexible wrap. This, however, may reduce the timing and efficiency that is so important in the fast food industry by requiring a two-step wrapping process that utilizes two separate stacks of containers, which in turn takes up valuable space in a store. Thus, there is a need for a package that combines a flexible member with a smaller container to achieve the advantages attendant to each without sacrificing wrapping efficiency or storage space.

Other food package constructions have combined a flexible member with a more rigid member. U.S. Pat. No. 3,964,669 to Sontag discloses a rigid but foldable member adhered to a flexible member, where the length of the rigid member equals the length of the flexible member. The rigid member folds and forms a sleeve so that the food article is surrounded on four sides, leaving two sides open. The flexible member partially wraps around the sleeve and covers the two sides left open by the sleeve. This combination of a container and a flexible wrap, however, is limited to only one type of inner container. Thus, the construction is not malleable enough to use for various types of food containers, so important in the fast food industry. Furthermore, because the flexible member is the same length as the rigid member, it does not provide much additional protection against dripping sauces and juices.

U.S. Pat. No. 5,963,534 to Welles discloses a bag of flexible material that is sealed around a food product. The top of the bag is ripped open at a seam, and one side folds outward and downward, providing a covering for the consumer's hands. The bottom of the bag remains closed, forming a pocket that holds the food. However, this construction requires that the food be sealed within the product during packaging. As a result, it is not feasible to use this packaging in a restaurant setting where food products are ordered by a consumer, packaged by workers, and handed over to the consumer in a time period of a few minutes.

U.S. Pat. No. 2,016,462 to Stokes discloses a method for wrapping a rigid member with a flexible member, where a conveying means brings a box blank together with a wrapper of substantially the same size, layered with adhesive, and fastens them together. Such a package has deficiencies similar to those described above. That is to say, the process is restricted to producing packages that contain a limited variety of containers and wrap sizes.

It is therefore the broad object of the invention to provide a food package that combines the advantages of a flexible wrap and a container while still maintaining the ability to wrap a food product in a fast food environment. A further object of the invention is to provide a method for combining a flexible wrap and a food container in a cost efficient, one-step process that is easily adjustable to a variety of container and wrap sizes.

### SUMMARY OF THE INVENTION

In the present invention, these purposes, as well as others which will be apparent, are achieved generally by providing a method for combining individual paper bags or folding cartons with a conventional wrap material to form a combined container and wrap food package. Additionally, the invention is concerned with an apparatus and method for producing a food storage and service package comprising a food container attached to a flexible wrap.

The present invention provides an improved construction for a food packaging that contains a container for supporting the food product attached to a flexible wrap, where the flexible wrap is substantially larger than the container.

The invention further includes a method and apparatus of unwrapping and cutting of a wrap material on the same vacuum belt assembly as an adhesive application and a hopper feeder. The method of making the above food package comprises the steps of: unwinding wrap material, depositing the wrap material onto a vacuum belt, cutting it to a desired size, conveying cut wrap to a conventional adhesive applicator such as a nozzle or group of nozzles for spraying the adhesive in a desired pattern or to a desired location on the wrap material, delivering a container by a hopper feeder onto the wrap material, attaching container to wrap by vacuum feeding the container onto the wrap where the adhesive was applied.

Other objects, features and advantages of the present invention will be apparent when the detailed description of the preferred embodiments of the invention are considered in conjunction with the drawings which should be construed in an illustrative and not limiting sense.

### BRIEF DESCRIPTION OF THE FIGURES/DRAWINGS

FIG. 1 is a front view of a combined container and flexible wrap where the food container is a soft textured pinch bottom bag.

FIG. 2 is a front view of a combined container and flexible wrap where the food container is a pop-up-scoop design.

FIGS. 3A-3D are illustrations showing how a food product may be inserted into a combined container and flexible wrap, wrapped, opened and how it may be eaten.

FIG. 4 shows a side view of an apparatus for combining a food container with a flexible wrap.

### DETAILED DESCRIPTION

Referring now to the drawings wherein the showings are for the purpose of illustrating preferred embodiments of the invention, and not for the purpose of limiting the invention.

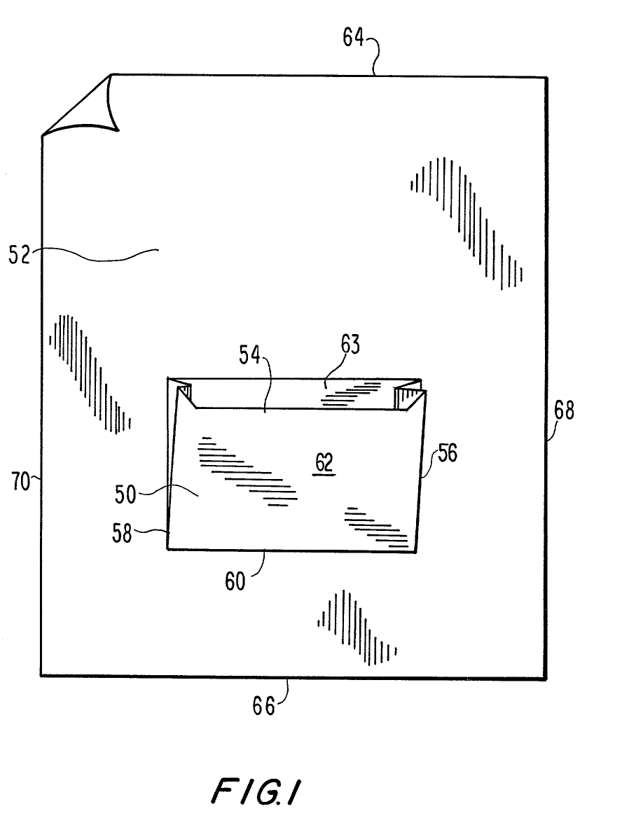

FIG. 1 depicts a combined food package comprising a container 50 fastened to a flexible wrap 52. The container may be any type of container of any material suitable for holding a food item, including but not limited to pop-up scoops, pinch bottom bags and autobottom cartons. In preferred embodiments, the inner container is a pinch bottom bag. The pinch bottom bag consists of an open front 54, two sides 56 and 58 that contain gussets to allow for size expansion, and a closed bottom 60. The inner container also contains a top side 62 and a bottom side 63 opposite the top side.

The reverse side of bottom side 63, the side that touches the wrap, is fastened to the flexible wrap 52. The fastener is an adhesive suitable for attaching the inner container 50 to the flexible wrap 52 so that the container is sufficiently fastened to a location on the flexible wrap. The adhesive is preferably a peelable hot melt material, although it may be a cold glue or other suitable adhesive. The type of adhesive used will depend on the type of substrate used. The adhesive may be applied to the entire area of bottom side 63, or in spots, or just along one edge of the bottom side 63.

Flexible wrap 52 may be of any material suitable for wrapping. It contains a top side 64, and bottom side 66, and connecting sides 68 and 70. In preferred embodiments, the paper is paper and polyethylene. Other types of usable paper substrates include paper and wax, foil. The paper substrates may be of either bleached or unbleached kraft.

The wrap is substantially larger than the container to ensure easy wrapping and to provide ample protection for the consumer against food product juices and sauces. In preferred embodiments, the flexible wrap has a length of 9 to 15 inches for sides 68 and 70, and a width of 9 to 15 inches for sides 64 and 66. In FIG. 1, the wrap has a length of 14 inches and a width of 12 inches. In contrast, the container has a length of 3.5 inches for sides 56 and 58, a width of 6 inches for sides 54 and 60. Thus, in the example shown in FIG. 1, the flexible wrap has 400% greater length and 100% greater width than the container. If food is entered into the pinch bottom bag, the gussets on sides 56 and 58 may be pushed outwards, up to a half an inch on each side, so that the total width of the container would be 7 inches. In this instance, the flexible wrap would have a width dimension about 70% larger than the width dimension of the container.

These percentages can vary depending on the size of the container. However, the wrap may be any length that covers the entire container sufficiently. Thus, the wrap should have dimensions at least about 70% greater length and width than the dimensions of the container, where the wrap will be sufficient to fully enclose the container. In this instance, the wrap will be substantially large enough to protect the consumer from dripping sauces and juices.

The location of the container in FIG. 1 is slightly off from the center of the flexible wrap, so that the sandwich can be built on the wrap and immediately be slid into the container. However, the exact location the container is adhered to the wrap can be changed without altering the spirit of the invention.

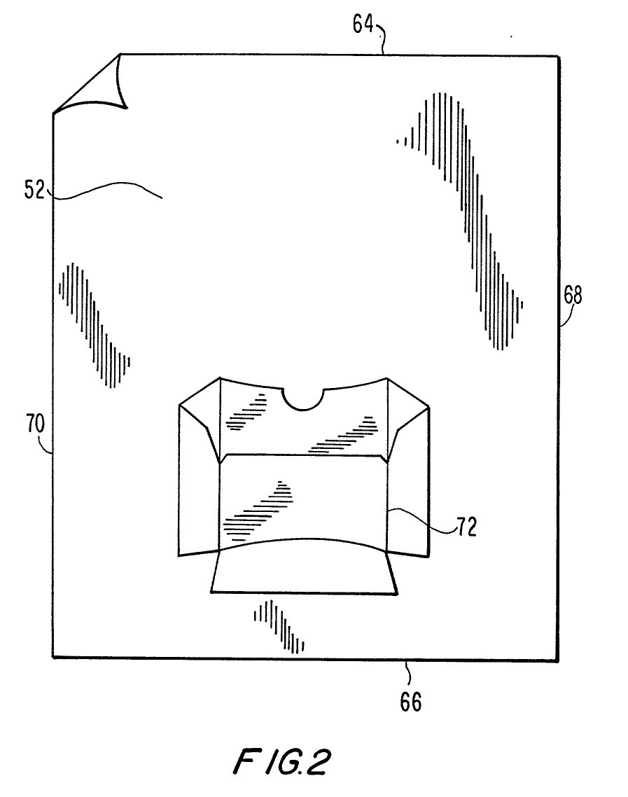

Another type of container is shown in FIG. 2. The container 72 is a pop-up scoop design. The container may be fastened to the flexible member in a flattened state in order to increase stackability and to conserve space. When wrapping, a worker can quickly pop up the container, which locks into place. Thereafter, a food item can be placed into the container and wrapped with the flexible wrap. This embodiment supplies rigidity in the container, largely protecting the food product from crushing allowing the consumer to consume the food without touching it directly with their hands. The embodiment also simultaneously provides a flexible wrap, substantially larger than the container, which protects the consumer from dripping juices and sauces.

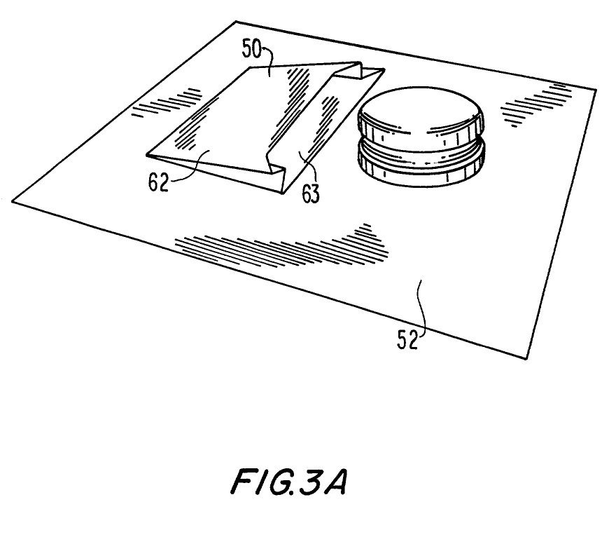

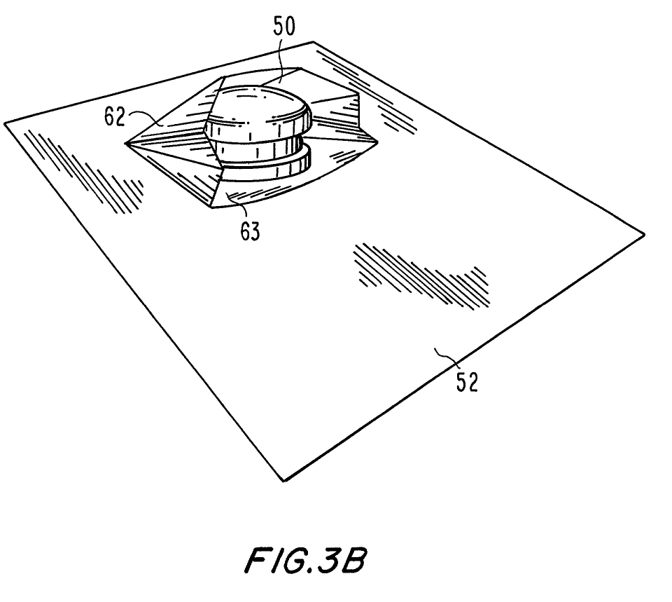

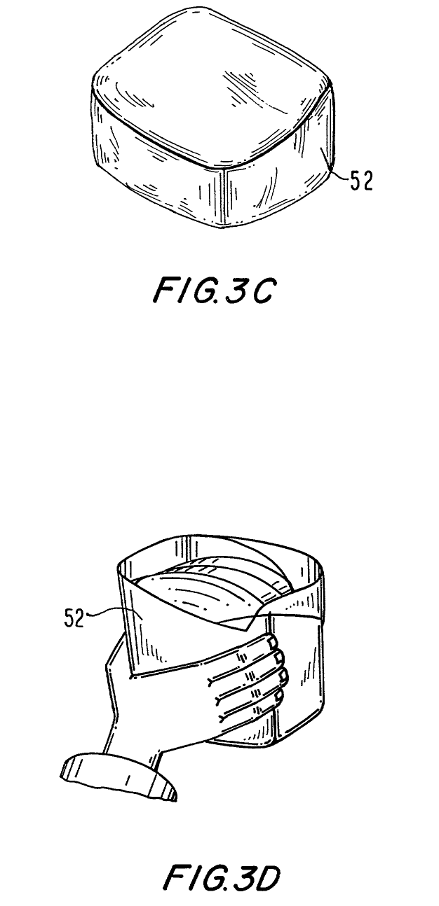

FIGS. 3A-3D depict a food product utilized with an embodiment of the combined container and wrap. FIG. 3A shows the beginning of the wrapping process. The food is placed or built on the wrap above the open-ended potion of the container. In FIG. 3B, the food has been pushed into the container. This is made easier if the container is adhered to the wrap so that the top edge of the container's bottom side 63 is fastened tight to the wrap. This will prevent the container from flapping up on that end, which can be an inconvenience in the wrapping process. After the food is in the container, the wrap is wrapped around the container, completing the package as shown in FIG. 3C.

The consumer may eat the food as depicted in FIG. 3D. Here the consumer is using the wrap to protect the consumer's hands from heat and dripping juices and sauces, while still being able to consume the food while it is still in the container.

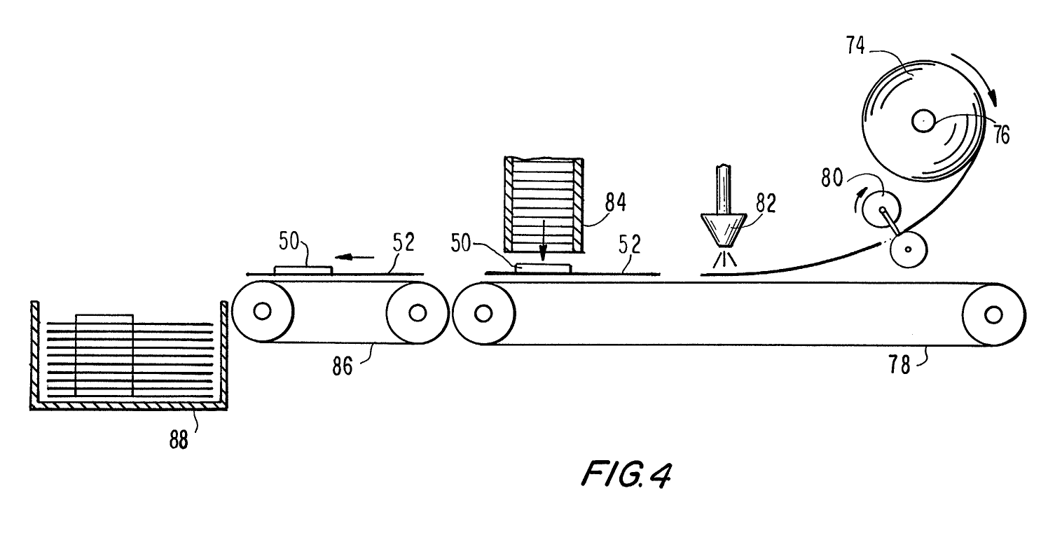

An apparatus and method for making the food package is detailed in FIG. 4. The method consists of unwinding wrap material, cutting the wrap material into a desired size, depositing the wrap material onto a vacuum belt, conveying cut wrap to a adhesive applicator for applying the adhesive in a desired pattern or to a desired location on the wrap material, delivering a container by a hopper feeder onto the wrap material, attaching a container to the wrap by vacuum feeding the container onto the wrap where the adhesive was applied, and delivering combined wrap and container to a bin.

A roll of uncut flexible wrap material 74 is loaded onto a holder 76. The roll may be of any size, preferably 24-30 inches. The holder may be of any type suitable for dispatching and unrolling the uncut flexible paper.

The wrap is unrolled and deposited onto a vacuum belt 78, which sufficiently keeps the wrap in place while moving it along the belt. The belt may be either grooved or flat. The speed of the vacuum belt may be any desired speed, preferably above 200 linear feet per minute.

The wrap is conveyed past a cutting head 80, which cuts the wrap into the desired length. The cutting head 80 is a blade type of rotary die. The preferred circumference of the rotary die is 14 inches, which will produce corresponding wraps of 14 inches long. Artisans will understand, however, that the rotary die's surface area corresponds to the size of the cut wrapper. That is to say, the larger the rotary die's surface area, the larger the length of the cut wrap, and vice versa. Thus, any desired wrap lengths can be chosen by using rotary dies of different lengths and radii. Alternatively, a die with multiple slots can be used, so that multiple blades may fit into a single die. This allows a single die to create multiple lengths of cut wraps. Other cutting devices known in the art may also be used.

After the die cuts the wrap into the desired length, the wrap is conveyed along the vacuum belt to an adhesive applicator 82, preferably a nozzle or group of nozzles for spraying an adhesive in a desired pattern or to a desired location on the wrap material. Alternatively, the adhesive can be applied with non-nozzle applicators, such as wheel type extrusions.

The applicator applies the adhesive in a pattern that sufficiently holds the container in place. At the same time, the applicator does not apply more adhesive than is necessary, which is wasteful and uneconomical. In preferred embodiments, the container is sealed onto the wrap so that the top edge of the bottom of the container is sealed tight against the wrap. This facilitates the easy placement of a food item into the container without dealing with unwanted flaps. Those skilled in the art will realize that alternative patterns may be developed depending on the substrate or product.

After the applicator applies the adhesive in the desired pattern on the desired location of the wrap, the wrap is conveyed along the vacuum belt to a hopper feeder 84. The hopper feeder is preferably a rotary beater. The rotary beater is loaded with the food container of choice. The rotary beater is timed so that it registers the container onto the cut wrap where the adhesive was applied to form a combined food package. Timing can be achieved with an electric eye or other types of sensors.

The wrap and container combination is then moved to a subsequent vacuum belt 86 that runs at a different speed than vacuum belt 78. The subsequent vacuum belt may have a speed that runs faster or slower than the first vacuum belt. If the speed of the subsequent belt is quicker, the combined wraps and containers will separate from each other. Alternatively, if the speed of the second vacuum is slower, the combined wraps and containers will stack together.

The speed of the second vacuum belt may be of any speed that separates or stacks the wrap and container combination efficiently and without causing any damage. Alternatively, the second vacuum belt may not be used. In this instance, the cut wrap and container combination may be separated by a different method, such as manually.

The wrap and container combination is moved along the second vacuum belt and deposited into a bin 88 for holding the finished product. The bin may be changed or emptied as seen fit. The combination wrap and container may also be deposited directly into a box that can be sealed for shipment to a customer.

Although the invention has been described with reference to a preferred embodiment, it will be appreciated by one of ordinary skill in the art that numerous modifications are possible in light of the above disclosure. For example, the container may be placed in various positions and orientation on the wrap sheet to facilitate assembly of a sandwich and wrapping of the finished product. All such variation and modifications are intended to be within the scope and spirit of the invention.

What is claimed is:

1. A package for containing a food comprising a container for supporting the food attached to a flexible wrap, said flexible wrap having length and width dimensions substantially larger than the length and width dimensions of said container.

2. A package according to claim 1, wherein the length and width dimensions of the flexible wrap are at least 70% greater than the length and width dimensions of the container.

3. A package according to claim 1, wherein the length and width dimensions of the flexible wrap are of sufficient size to fully enclose the container.

4. A package according to claim 1, wherein the flexible wrap has a length of 9 to 15 inches and a width of 9 to 15 inches.

5. A package according to claim 1, wherein the container for supporting the food is selected from the group consisting of pinch bottom bags, pop-up scoops and autobottoms.

6. A package according to claim 1, wherein the flexible wrap comprises a material selected from the group consisting of paper and polyethylene, foil, or paper and wax.

7. A package according to claim 1, wherein the container is attached to the flexible wrap with an adhesive material.

8. A package according to claim 7, wherein the adhesive material is a peelable hot melt material.

9. Method for making a combined container and flexible wrap, comprising the steps of
(a) unwinding flexible wrap material from a roll onto a vacuum belt;
(b) cutting said flexible wrap material from the roll to form a cut flexible wrap;
(c) applying adhesive to the cut wrap material in a desired location and pattern;
(d) placing a container onto said adhesive;
(e) attaching said container to said wrap by vacuum feeding the container onto the wrap where said adhesive was applied.

10. Method for making the combined container and flexible wrap of claim 9, wherein flexible wrap material is cut from the roll to a desired size with a rotary blade die.

11. Method for making the combined container and flexible wrap of claim 9, wherein the cut flexible wrap is a size having length and width dimensions substantially larger than the length and width dimensions of the container.

12. Method for making the combined container and flexible wrap of claim 9, wherein the length and width dimensions of the cut flexible wrap are at least 70% greater than the length and width dimensions of the container.

13. Method for making the combined container and flexible wrap of claim 9, wherein the length and width dimensions of the cut flexible wrap are of sufficient size to fully enclose the container.

14. Method for making the combined container and flexible wrap of claim 9 wherein the cut flexible wrap has a length of 9 to 15 inches and a width of 9 to 15 inches.

15. Method for making the combined container and flexible wrap of claim 9, further comprising the step of conveying the completed container and flexible wrap combination into a bin made for holding said completed container and flexible wrap combination.

16. Method for making the combined container and flexible wrap of claim 9, further comprising a second vacuum belt placed immediately after the first vacuum belt, where the second vacuum belt receives the completed container and flexible wrap combination from said first vacuum belt.

17. Method for making the combined container and flexible wrap of claim 16, wherein the second vacuum belt moves at a rate faster than the rate of said first vacuum belt.

18. Method for making the combined container and flexible wrap of claim 16, wherein the second vacuum belt moves at a rate slower than the rate of said first vacuum belt.

19. Method for making the combined container and flexible wrap of claim 9, wherein said adhesive applicator is a nozzle or group of nozzles for spraying the adhesive in a desired pattern and to a desired location on the wrap material.

20. Apparatus for making a combined container and flexible wrap, which comprises
(a) a holder for holding a roll of flexible wrap;
(b) means for cutting the flexible wrap into a cut wrap;
(c) a conveyer belt for conveying the cut wrap;
(d) an adhesive applicator where adhesive is applied to the cut wrap;
(e) delivering means for placing a container onto said adhesive;
(f) attaching means for attaching said container onto said flexible wrap where the adhesive was applied, resulting in a combined container and flexible warp.

21. An apparatus according to claim 20, wherein means for cutting the flexible wrap is a rotary blade die.

22. An apparatus according to claim 20, further comprising a second conveyer belt immediately after the first conveyer belt, for receiving the combined flexible wrap and container from said first conveyer belt.
